(19) United States
(12) Patent Application Publication
(10) Pub. No.: US 2024/0084897 A1
(43) Pub. Date: Mar. 14, 2024

(54) Sealing Ring and Connector Assembly

(71) Applicant: Illinois Tool Works Inc., Glenview, IL (US)

(72) Inventor: Cong CAO, Shanghai (CN)

(21) Appl. No.: 18/242,620

(22) Filed: Sep. 6, 2023

(30) Foreign Application Priority Data
Sep. 13, 2022 (CN) 2022111121057

(51) Int. Cl. F16J 15/3284

(52) U.S. Cl. CPC F16J 15/3284

(57) ABSTRACT

The present disclosure provides a sealing ring, which comprises an annular base, an inside sealing portion, and an outside sealing portion. The annular base comprises an inner annular side and an outer annular side. The inside sealing portion protrudes inwardly from the inner annular side. The outside sealing portion protrudes outwardly from the outer annular side. At least one of the inside sealing portion and the outside sealing portion has a contour undulating in an axial direction of the annular base or inclined with respect to a radial direction of the annular base. The sealing ring according to the present disclosure is used for a sealing between side surfaces of two components (such as a male connector and a female connector of a connector assembly) that cooperate with each other by insertion, and by the above configuration, an insertion force that an operator needs to apply during the insertion operation between the two components can be reduced.

### RELATED APPLICATION

The present application claims the benefit of Chinese Patent Application No. CN 2022111121057, filed Sep. 13, 2022, titled “Sealing Ring and Connector Assembly,” the contents of which are hereby incorporated by reference.

### TECHNICAL FIELD

The present disclosure relates to a sealing ring, and in particular, to a sealing ring used between side surfaces of two components that cooperate with each other by insertion.

### BACKGROUND

During device mounting, it is often necessary to assemble two components (such as a male connector and a female connector of a connector assembly) together by insertion. In order to form a seal between the two components, a sealing ring should be mounted between side surfaces of the two components. The sealing ring is usually first retained in a groove provided in one of the two components, and then when the two components cooperate with each other by insertion, the sealing ring is in dynamic contact with the other component and is pressed and deformed, so as to connect the side surfaces of the two components in a sealing manner. The sealing ring used in the prior art is usually of an annular structure with a uniform circumferential shape. An outer edge and an inner edge of the sealing ring, which are used to form sealing surfaces, are respectively in the shape of arc-shaped protrusions extending in a ring shape.

### SUMMARY OF THE DISCLOSURE

Through observation, the inventors of the present disclosure have found that in an insertion operation between two components, when an outer edge or an inner edge of a sealing ring in the prior art is in contact with a component in dynamic contact therewith, the outer edge or the inner edge of the sealing ring may usually apply relatively high resistance to the component in dynamic contact therewith, so that an operator needs to apply a relatively large insertion force to achieve the insertion operation. Through research, the inventors of the present disclosure have found that the reason why the operator needs to apply the relatively large insertion force is that, when the outer edge or the inner edge of the sealing ring in the prior art that is used to form a sealing surface comes into dynamic contact with the inserted component, since the shape of the sealing ring is uniform in a circumferential direction, all parts of the outer edge or the inner edge of the sealing ring on the entire circumference are pressed and deformed by the inserted component at the same time, so that all the parts in the entire circumferential direction generate resistance to the inserted component, and thus a peak value of the insertion force applied by the operator is relatively large.

In view of this, according to a first aspect of the present disclosure, the present disclosure provides a sealing ring, which comprises an annular base, an inside sealing portion, and an outside sealing portion. The annular base comprises an inner annular side and an outer annular side. The inside sealing portion protrudes inwardly from the inner annular side. The outside sealing portion protrudes outwardly from the outer annular side. At least one of the inside sealing portion and the outside sealing portion has a contour undulating in an axial direction of the annular base or inclined with respect to a radial direction of the annular base.

In the sealing ring according to the above first aspect, the undulating contour forms a wavy contour.

In the sealing ring according to the above first aspect, the inclined contour comprises one highest point and one lowest point.

In the sealing ring according to the above first aspect, the undulating contour comprises at least two highest points and at least two lowest points, wherein the at least two highest points are arranged rotationally symmetrically with respect to an axis of the annular base, and the at least two lowest points are arranged rotationally symmetrically with respect to the axis of the annular base.

In the sealing ring according to the above first aspect, each of the inside sealing portion and the outside sealing portion has the contour undulating in the axial direction of the annular base or inclined with respect to the radial direction of the annular base.

In the sealing ring according to the above first aspect, the contour of the inside sealing portion and the contour of the outside sealing portion undulate or are inclined synchronously with respect to the annular base.

In the sealing ring according to the above first aspect, the contour of the inside sealing portion and the contour of the outside sealing portion undulate or are inclined asynchronously with respect to the annular base.

In the sealing ring according to the above first aspect, the inside sealing portion and the outside sealing portion each have a sealing surface with arc-shaped cross-sections.

In the sealing ring according to the above first aspect, the annular base comprises a first end and a second end in the axial direction. The contour comprises a first portion which is closer to the first end and a second portion which is closer to the second end, and the contour is configured such that during deformation of the contour being pressed by a component in dynamic contact therewith, the first portion of the contour is pressed and deformed by the component before the second portion, and when the first portion of the contour is pressed and deformed by the component, the second portion of the contour has not been in contact with the component or is not pressed and deformed by the component.

In the sealing ring according to the above first aspect, the annular base, the inside sealing portion and the outside sealing portion are integrally formed.

According to a second aspect of the present disclosure, the present disclosure provides a connector assembly, which comprises a female connector, a male connector, and a sealing ring according to the above first aspect. The male connector is inserted into the female connector. The sealing ring is arranged between an outer side of the male connector and an inner side of the female connector to achieve a sealing between the outer side of the male connector and the inner side of the female connector.

In the connector assembly according to the above second aspect, the outer side of the male connector is provided with a male connector accommodation groove in which the sealing ring is at least partially retained; or the inner side of the female connector is provided with a female connector accommodation groove in which the sealing ring is at least partially retained.

### BRIEF DESCRIPTION OF THE DRAWINGS

The foregoing and other objects, features, and advantages of the devices, systems, and methods described herein will be apparent from the following description of particular examples thereof, as illustrated in the accompanying figures; where like or similar reference numbers refer to like or similar structures. The figures are not necessarily to scale, emphasis instead being placed upon illustrating the principles of the devices, systems, and methods described herein.

FIG. 1A is a perspective view of a sealing ring according to an embodiment of the present disclosure.

FIG. 1B is a front view of the sealing ring shown in FIG. 1A.

FIG. 1C is a sectional view of the sealing ring shown in FIG. 1A along line C-C.

FIG. 1D is a sectional view of the sealing ring shown in FIG. 1A along line D-D.

FIG. 2A is a perspective view of an embodiment of a connector assembly using the sealing ring shown in FIG. 1A.

FIG. 2B is an exploded view of the connector assembly shown in FIG. 2A.

FIG. 2C is a sectional view, taken along an axis, of the connector assembly shown in FIG. 2A.

FIG. 2D is a sectional view, taken along an axis, of the connector assembly shown in FIG. 2A during assembly.

FIG. 3A is a perspective view of another embodiment of a connector assembly using the sealing ring shown in FIG. 1A.

FIG. 3B is an exploded view of the connector assembly shown in FIG. 3A.

FIG. 3C is a sectional view, taken along an axis, of the connector assembly shown in FIG. 3A.

FIG. 3D is a sectional view, taken along an axis, of the connector assembly shown in FIG. 3A during assembly.

FIG. 4A is a perspective view of a sealing ring according to another embodiment of the present disclosure.

FIG. 4B is a front view of the sealing ring shown in FIG. 4A.

FIG. 4C is a sectional view of the sealing ring shown in FIG. 4A along line E-E.

FIG. 4D is a sectional view of the sealing ring shown in FIG. 4A along line F-F.

### DETAILED DESCRIPTION

Various specific embodiments of the present disclosure will be described below with reference to the accompanying drawings which form a part of this description. It should be understood that although the terms indicating directions, such as “front”, “rear”, “upper”, “lower”, “left”, “right”, “top”, and “bottom” are used in the present disclosure to describe structural parts and elements in various examples of the present disclosure, these terms are used herein only for ease of illustration and are determined based on the exemplary orientations shown in the accompanying drawings. Since the embodiments disclosed in the present disclosure can be arranged in different directions, these terms indicating directions are merely illustrative and should not be considered as limitations.

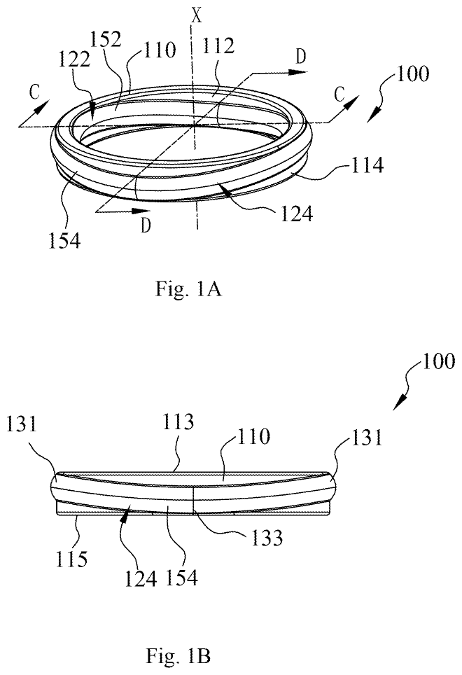

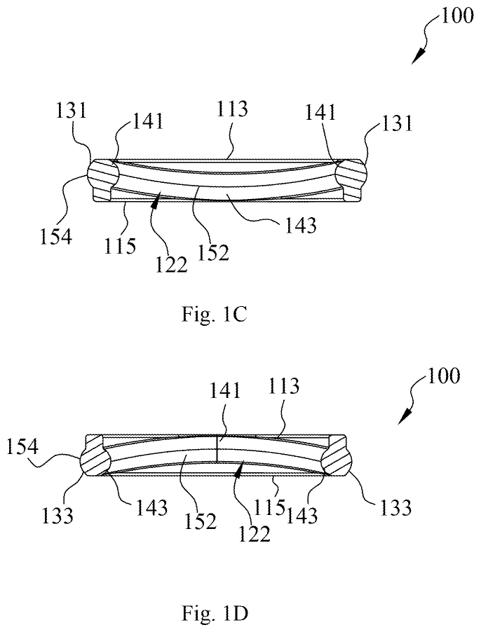

FIGS. 1A through 1D show a specific structure of a sealing ring 100 according to an embodiment of the present disclosure, among which FIG. 1A is a perspective view of the sealing ring 100, FIG. 1B is a front view of the sealing ring 100, FIG. 1C is a sectional view of the sealing ring 100 along line C-C of FIG. 1A, and FIG. 1D is a sectional view of the sealing ring 100 along line D-D of FIG. 1A. The sealing ring 100 is used for sealing between side surfaces of two components (such as a male connector and a female connector of a connector assembly) that cooperate with each other by insertion, and the design of the sealing ring can reduce an insertion force that an operator needs to apply during the insertion operation between the two components.

As shown in FIGS. 1A and 1B, the sealing ring 100 comprises an annular base 110, an inside sealing portion 122, and an outside sealing portion 124. The annular base 110 is substantially in a flat annular shape with an axis X. The annular base 110 comprises an inner annular side 112 and an outer annular side 114 provided around the axis X, and a first end 113 and a second end 115 at opposite axial ends thereof. The inside sealing portion 122 is provided on the inner annular side 112 of the annular base 110, and protrudes inwardly from the inner annular side 112. The outside sealing portion 124 is provided on the outer annular side 114 of the base 110, and protrudes outwardly from the outer annular side 114. The inside sealing portion 122 and the outside sealing portion 124 each form an annular shape, and extend continuously in an entire circumferential direction of the annular base 110. The inside sealing portion 122 and the outside sealing portion 124 are integrally made of an elastic sealing material together with the annular base 110. The inside sealing portion 122 and the outside sealing portion 124 are respectively configured to be in contact with side surfaces of two components that cooperate with each other by insertion, to achieve a connection between the side surfaces of the two components in a sealing manner. Since the inside sealing portion 122 and the outside sealing portion 124 are elastic, the inside sealing portion 122 and the outside sealing portion 124 can be deformed when subjected to a pressing force from a component in dynamic contact therewith.

As shown in FIGS. 1A through 1D, the outside sealing portion 124 of the sealing ring 100 has a contour undulating in an axial direction of the annular base 110. The undulating contour means that if the outside sealing portion 124 is divided into a plurality of portions in the circumferential direction, when viewed along the axis of the annular base 110, some of the plurality of portions are located at different height positions with respect to the axial direction of the annular base 110, but not all the portions are located at the same height position. Therefore, the undulating contour has a portion (a first portion) which is closer to the first end 113 of the annular base 110, and a portion (a second portion) which is closer to the second end 115 of the annular base. During deformation of the undulating contour being pressed by a component in dynamic contact therewith, the first portion of the contour is first pressed by the component, and when the first portion of the contour is pressed and deformed by the component, the second portion of the contour is not in contact with the component or is not pressed and deformed by the component. In the embodiment shown in the figure, the undulating contour of the outside sealing portion 124 forms a wavy contour. That is, when viewed from a direction perpendicular to the axis X of the annular base 110, the outside sealing portion 124 presents a wavy shape.

As shown in FIGS. 1B through 1D, a portion of the outside sealing portion 124 with the undulating contour, that is closest to the first end 113 of the annular base 110, is a highest point 131, and a portion thereof that is closest to the second end 115 of the annular base 110 is a lowest point 133. The outside sealing portion 124 comprises two highest points 131 and two lowest points 133, and portions extending between the highest points 131 and the lowest points 133 with respect to a radial direction of the annular base 110. The two highest points 131 are arranged rotationally symmetrically with respect to the axis X of the annular base 110, and the two lowest points 133 are also arranged rotationally symmetrically with respect to the axis X of the annular base 110. Moreover, the two highest points 131 and the two lowest points 133 are jointly arranged rotationally symmetrically with respect to the axis X of the annular base 110. Therefore, the two highest points 131 and the two lowest points 133 are uniformly arranged around the axis X at equal angles, the two highest points 131 are located at the same height position with respect to the axis X, and the two lowest points 133 are located at the same height position with respect to the axis X.

The inside sealing portion 122 is configured in a manner similar to that of the outside sealing portion 124. Specifically, the inside sealing portion 122 comprises two highest points 141 and two lowest points 143, and portions extending between the highest points 141 and the lowest points 143. The two highest points 141 are close to the first end 113 of the annular base 110, and the two lowest points 143 are close to the second end 115 of the annular base 110. The two highest points 141 are arranged rotationally symmetrically with respect to the axis X of the annular base 110, and the two lowest points 143 are also arranged rotationally symmetrically with respect to the axis X of the annular base 110. Moreover, the two highest points 141 and the two lowest points 143 are jointly arranged rotationally symmetrically with respect to the axis X of the annular base 110. Therefore, the two highest points 141 and the two lowest points 143 are uniformly arranged around the axis X at equal angles, the two highest points 141 are located at the same height position with respect to the axis X, and the two lowest points 143 are located at the same height position with respect to the axis X.

In addition, the inside sealing portion 122 and the outside sealing portion 124 undulate synchronously with respect to the annular base 110. The so-called undulate synchronously means that the highest points 141 of the inside sealing portion 122 and the highest points 131 of the outside sealing portion 124 are directly opposite each other across the annular base 110, and the lowest points 143 of the inside sealing portion 122 and the lowest points 133 of the outside sealing portion 124 are directly opposite each other across the annular base 110. If viewed from a side of the sealing ring 100 (for example, from the perspective shown in FIG. 1B), the outside sealing portion 124 exactly blocks the inside sealing portion 122. Of course, in some other embodiments, the inside sealing portion 122 and the outside sealing portion 124 may also be configured to undulate asynchronously with respect to the annular base 110, so that the highest points 141 of the inside sealing portion 122 and the highest points 131 of the outside sealing portion 124 are staggered with each other in the circumferential direction of the annular base 110, the lowest points 143 of the inside sealing portion 122 and the lowest points 133 of the outside sealing portion 124 are also staggered with each other in the circumferential direction of the annular base 110, and if viewed from a side of the sealing ring 100 (for example, from the perspective shown in FIG. 1B), the outside sealing portion 124 cannot completely block or does not block the inside sealing portion 122. As shown in FIG. 1A, due to the undulating contour, the entire inside sealing portion 122 presents a twisted annular shape, and the entire outside sealing portion 124 also presents a twisted annular shape. Therefore, on any circumference around the axis X, neither the inside sealing portion 122 nor the outside sealing portion 124 is of a structure with a uniform shape, but is of a shape-changing structure.

An outer surface of the outside sealing portion 124 forms an outside sealing surface 154 (see FIGS. 1A and 1B), and an outer surface of the inside sealing portion 122 forms an inside sealing surface 152 (see FIGS. 1A, 1C and 1D). As shown in FIGS. 1C and 1D, the inside sealing surface 152 and the outside sealing surface 154 are arc-shaped on the cross section of the sealing ring 100.

The sealing ring 100 according to the present disclosure is used for a sealing between side surfaces of two components (an inserting member and a receiving member) that cooperate with each other by insertion, and the sealing ring can reduce an insertion force that an operator needs to apply. This will be described in detail with reference to an application of the sealing ring 100 according to the present disclosure in a connector assembly.

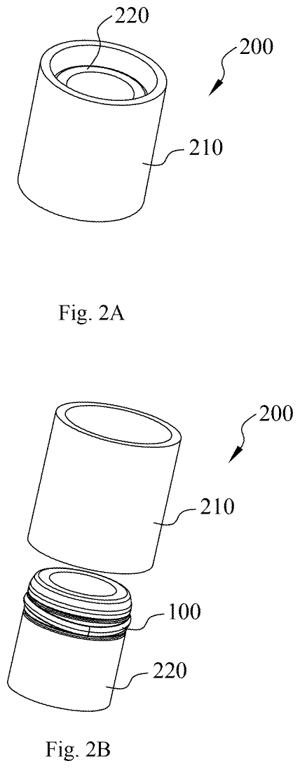

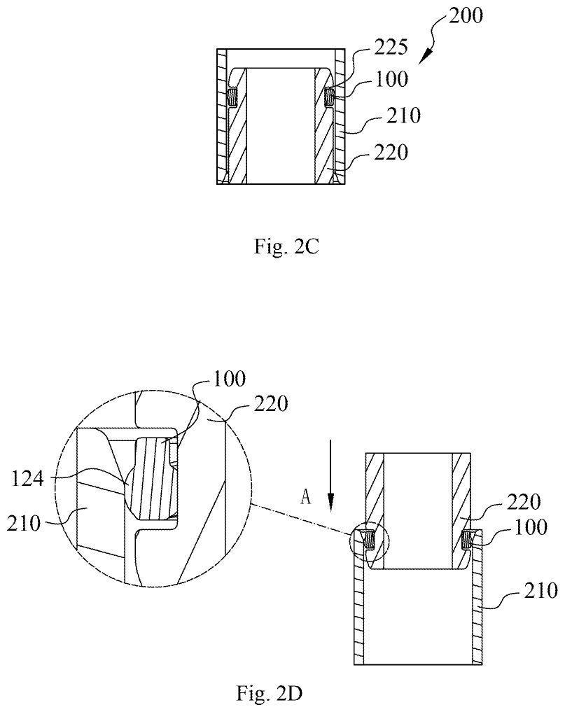

FIGS. 2A through 2D show a specific structure of an embodiment of a connector assembly using the sealing ring 100 shown in FIG. 1A, among which FIG. 2A is a perspective view of the connector assembly 200, FIG. 2B is an exploded view of the connector assembly 200, FIG. 2C is a sectional view, taken along an axis, of the connector assembly 200, and FIG. 2D is a sectional view, taken along an axis, of the connector assembly 200 during assembly. As shown in FIGS. 2A through 2C, the connector assembly 200 comprises a female connector 210 and a male connector 220. The female connector 210 is a receiving member, the male connector 220 is an inserting member, the male connector 220 is inserted into the female connector 210, and the sealing ring 100 is located between an inner side of the female connector 210 and an outer side of the male connector 220 to connect the inner side of the female connector 210 to the outer side of the male connector 220 in a sealing manner. The outer side of the male connector 220 is provided with a male connector accommodation groove 225, which is formed by recessing inwardly from an outer surface of the male connector 220. The sealing ring 100 is accommodated and retained in the male connector accommodation groove 225, so that the sealing ring 100 can be pre-assembled on the male connector 220. As shown in FIG. 2D, during assembly of the male connector 220 and the female connector 210, the sealing ring 100 is first pre-assembled on the male connector 220, and then a pre-assembled part of the male connector 220 and the sealing ring 100 is inserted into the female connector 210 in a direction of arrow A.

During assembly of the male connector 220 and the female connector 210, the outside sealing portion 124 of the sealing ring 100 is in dynamic contact with the inner side of the female connector 210, and is gradually inserted into the female connector 210. During assembly of the male connector 220 and the female connector 210, the magnitude of an insertion force that the operator needs to apply depends on two factors. The first factor is the magnitude of a blocking force generated by the deformation of the outside sealing portion 124 of the sealing ring 100, and the second factor is the magnitude of a friction force generated between the outside sealing portion 124 of the sealing ring 100 and the inner side of the female connector 210. The outside sealing portion 124 is deformed only during the insertion of the sealing ring 100 into the female connector 210. After the sealing ring 100 is completely inserted into the female connector 210, the outside sealing portion 124 of the sealing ring 100 is no longer deformed, although a relative movement between the male connector 220 and the female connector 210 may still occur.

During the insertion of the sealing ring 100 into the female connector 210, the outside sealing surface 154 of the outside sealing portion 124 of the sealing ring 100 comes into contact with the inner side of the female connector 210, and the insertion force applied by the operator is applied to the outside sealing surface 154 by means of the inner side of the female connector 210, so that the outside sealing portion 124 is pressed and deformed, and the deformation of the outside sealing portion 124 may generate a blocking force on the female connector 210.

As the sealing ring 100 according to the present disclosure is provided with the outside sealing portion 124 having the contour undulating in the axial direction, the inner side of the female connector 210, during the process of contacting the outside sealing surface 154 of the outside sealing portion 124, is first in contact with the highest point 131 of the outside sealing portion 124, and at an axial position where the highest point 131 is located, the part of the outside sealing portion 124 which contacts the inner side of the female connector 210 is very limited, and deformation occurs only at the highest point 131. Therefore, compared with contacting the inner side of the female connector 210 in the entire circumferential direction at the same time, contacting with the inner side of the female connector 210 only at the highest point 131 can greatly reduce the blocking force generated by the deformation of the outside sealing portion 124. Similarly, as the sealing ring 100 is gradually inserted into the female connector 210, the part of the outside sealing portion 124 in contact with the inner side of the female connector 210 gradually shifts from the highest point 131 to the lowest point 133, but at any moment, only some parts of the outside sealing portion 124 on the same circumference are in contact with the inner side of the female connector 210. Therefore, at any moment during the insertion of the sealing ring 100 into the female connector 210, the blocking force generated by the deformation of the outside sealing portion 124 is reduced. This means that the insertion force applied by the operator is reduced. Therefore, due to the provision of the outside sealing portion 124 with the contour undulating in the axial direction, a contact manner between the inner side of the female connector 210 and the outside sealing surface 154 of the outside sealing portion 124 is similar to segmented contact. This contact manner causes the insertion force to be split compared with contacting with the inner side of the female connector 210 in the entire circumferential direction at the same time, thereby reducing a peak value of the insertion force.

During insertion of the sealing ring 100 into the female connector 210, the outside sealing portion 124 is gradually flattened. After the sealing ring 100 is completely inserted into the female connector 210, the outside sealing portion 124 is no longer deformed, and thus the outside sealing portion 124 no longer applies a blocking force on the inserting member caused by deformation.

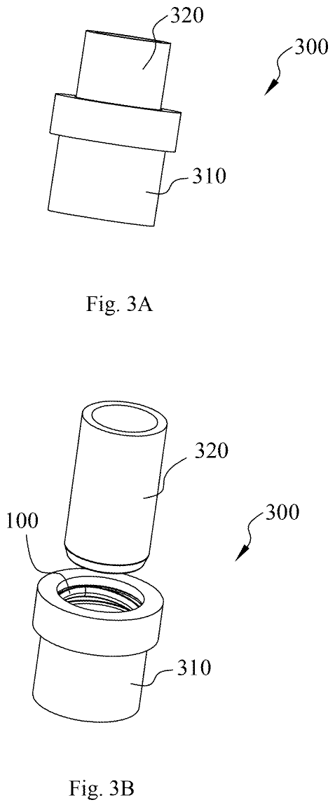

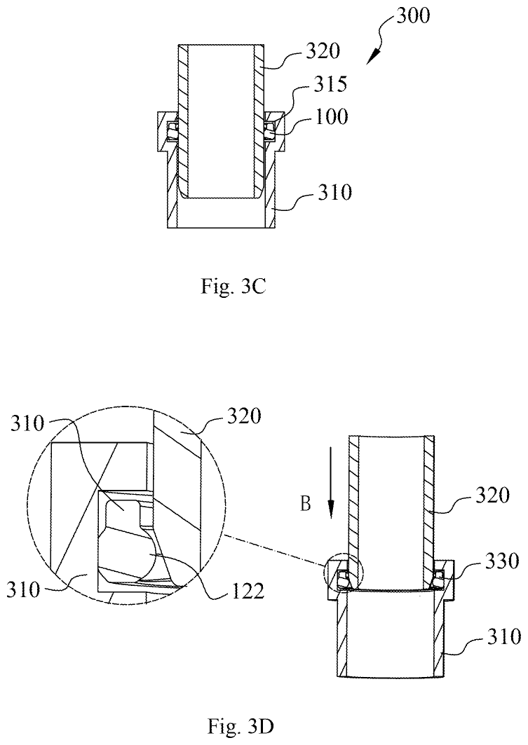

FIGS. 3A through 3D show a specific structure of another embodiment of a connector assembly using the sealing ring 100 shown in FIG. 1A, among which FIG. 3A is a perspective view of the connector assembly 300, FIG. 3B is an exploded view of the connector assembly 300, FIG. 3C is a sectional view, taken along an axis, of the connector assembly 300, and FIG. 3D is a sectional view, taken along an axis, of the connector assembly 300 during assembly. As shown in FIGS. 3A through 3C, the connector assembly 300 comprises a female connector 310 and a male connector 320. The female connector 310 is a receiving member, the male connector 320 is an inserting member, the male connector 320 is inserted into the female connector 310, and the sealing ring 100 is located between an inner side of the female connector 310 and an outer side of the male connector 320 to connect the inner side of the female connector 310 to the outer side of the male connector 320 in a sealing manner. The connector assembly 300 shown in FIGS. 3A through 3D differs from the connector assembly 200 shown in FIGS. 2A through 2D only in that in the connector assembly 200, the sealing ring 100 is pre-assembled on the male connector 220, while in the connector assembly 300, the sealing ring 100 is pre-assembled on the female connector 310. Specifically, the inner side of the female connector 310 is provided with a female connector accommodation groove 315, which is formed by recessing outwardly from an inner surface of the female connector 310. The sealing ring 100 is accommodated and retained in the female connector accommodation groove 315, so that the sealing ring 100 can be pre-assembled on the female connector 310. As shown in FIG. 3D, during assembly of the female connector 310 and the male connector 320, the sealing ring 100 is first pre-assembled on the female connector 310, and then the male connector 320 is inserted into a pre-assembled part of the female connector 310 and the sealing ring 100 in a direction of arrow B.

During assembly of the male connector 320 and the female connector 310, the male connector 320 may be gradually inserted into the sealing ring 100, and the inside sealing portion 122 of the sealing ring 100 will apply a blocking force on the male connector 320 due to deformation under force. However, since the inside sealing portion 122 has the same configuration as the outside sealing portion 124 described with reference to FIGS. 2A through 2D, the inside sealing portion 122 can also reduce the insertion force that the operator needs to apply when the male connector 320 is inserted into the sealing ring 100.

It should be noted that although in the embodiment of the present disclosure, the inside sealing portion 122 and the outside sealing portion 124 of the sealing ring 100 each are configured to have a contour undulating in the axial direction, in some other embodiments, it is only necessary to provide the sealing portion that is in dynamic contact with a cooperating component with a contour undulating in the axial direction. For example, in an application scenario shown in FIGS. 2A through 2D, since the sealing ring 100 is pre-assembled on the male connector 220, the outside sealing portion 124 of the sealing ring 100 is in dynamic contact with the female connector 210, and it is only necessary to configure the outside sealing portion 124 to have a contour undulating in the axial direction, and the inside sealing portion 122 may be configured to another shape. Similarly, in an application scenario shown in FIGS. 3A through 3D, since the sealing ring 100 is pre-assembled on the female connector 310, the inside sealing portion 122 of the sealing ring 100 is in dynamic contact with the male connector 320, and it is only necessary to configure the inside sealing portion 122 to have a contour undulating in the axial direction, and the outside sealing portion 124 may be configured to another shape.

In addition, although the wavy contour of the inside sealing portion 122/outside sealing portion 124 has two highest points and two lowest points in the embodiments of the present disclosure, in some other embodiments, the wavy contour of the inside sealing portion 122/outside sealing portion 124 may have more highest points and more lowest points, provided that the highest points/lowest points are arranged rotationally symmetrically with respect to the axis X of the annular base 110. By providing the highest points/lowest points that are rotationally symmetrical with respect to the axis X of the annular base 110, the present disclosure makes the blocking force applied by the deformation of the sealing ring and the friction force between the sealing ring and a component relatively uniform, so that the insertion operation is more stable and the sealing effect can be enhanced.

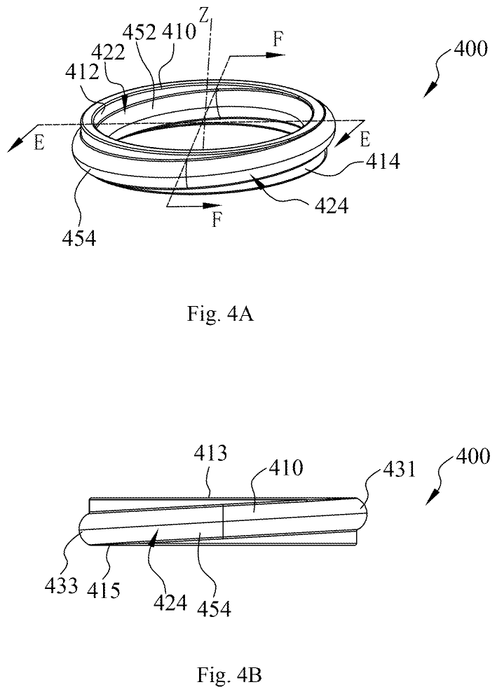

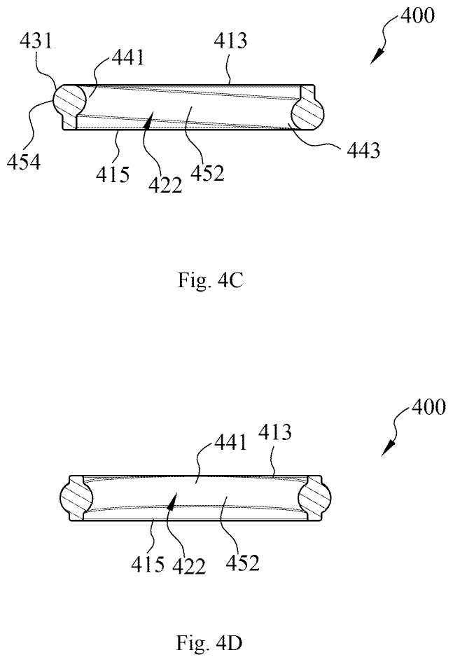

FIGS. 4A through 4D show a specific structure of a sealing ring 400 according to another embodiment of the present disclosure, among which FIG. 4A is a perspective view of the sealing ring 400, FIG. 4B is a front view of the sealing ring 400, FIG. 4C is a sectional view of the sealing ring 400 along line E-E of FIG. 4A, and FIG. 4D is a sectional view of the sealing ring 400 along line F-F of FIG. 4A. As shown in FIGS. 4A through 4D, the sealing ring 400 comprises an annular base 410, an inside sealing portion 422, and an outside sealing portion 424. The annular base 410 is substantially in a flat annular shape with an axis Z. The annular base 410 comprises an inner annular side 412 and an outer annular side 414 provided around the axis Z, and a first end 413 and a second end 415 at opposite axial ends thereof. The inside sealing portion 422 is provided on the inner annular side 412 of the annular base 410, and protrudes inwardly from the inner annular side 412. The outside sealing portion 424 is provided on the outer annular side 414 of the base 410, and protrudes outwardly from the outer annular side 414. The inside sealing portion 422 and the outside sealing portion 424 each form an annular shape, and extend continuously in an entire circumferential direction of the annular base 410. The inside sealing portion 422 and the outside sealing portion 424 are integrally made of an elastic sealing material together with the annular base 410. The inside sealing portion 422 and the outside sealing portion 424 are respectively configured to be in contact with side surfaces of two components that cooperate with each other by insertion, to achieve connection between the side surfaces of the two components in sealing manner. Since the inside sealing portion 422 and the outside sealing portion 424 are elastic, the inside sealing portion 422 and the outside sealing portion 424 can be deformed when subjected to a pressing force from a component in dynamic contact therewith.

The sealing ring 400 shown in FIGS. 4A through 4D differs from the sealing ring 100 shown in FIGS. 1A through 1D in that the contour of the inside sealing portion 122/outside sealing portion 124 of the sealing ring 100 is a contour undulating in the axial direction of the annular base 110, while the contour of the inside sealing portion 422/outside sealing portion 424 of the sealing ring 400 is a contour inclined with respect to a radial direction of the annular base 110. The so-called inclined contour means that the contour of the inside sealing portion 422/outside sealing portion 424 extends obliquely with respect to the radial direction of the annular base 410, rather than extending parallel to the radial direction of the annular base 410. That is to say, the inside sealing portion 422/outside sealing portion 424 extends obliquely with respect to the radial direction of the annular base 410 while extending in the circumferential direction of the inner annular side 412/outer annular side 414 of the annular base 410. Despite the above differences, like that of the sealing ring 100, the contour of at least one of the inside sealing portion 422 and the outside sealing portion 424 of the sealing ring 400 comprises a first portion which is closer to the first end 413 of the annular base 410 and a second portion which is closer to the second end 415 of the annular base 410, and the contour is configured such that during deformation of the contour being pressed by a component in dynamic contact therewith, the first portion of the contour is pressed and deformed by the component before the second portion, and when the first portion of the contour is pressed and deformed by the component, the second portion of the contour has not been in contact with the component or is not pressed and deformed by the component.

More specifically, as shown in FIGS. 4A through 4D, a portion of the outside sealing portion 424 with the inclined contour, that is closest to the first end 413 of the annular base 410, is a highest point 431, and a portion thereof that is closest to the second end 415 of the annular base 410 is a lowest point 433. The outside sealing portion 124 comprises only one highest point 431 and one lowest point 433, and portions extending obliquely between the highest point 431 and the lowest point 433 with respect to the radial direction of the annular base 410. The inside sealing portion 422 is configured in a manner similar to that of the outside sealing portion 424, and has one highest point 441 and one lowest point 443, and portions extending obliquely between the highest point 441 and the lowest point 443 with respect to the radial direction of the annular base 410. In addition, the inside sealing portion 422 and the outside sealing portion 424 are inclined synchronously with respect to the annular base 110. The so-called inclined synchronously means that the highest points 441 of the inside sealing portion 422 and the highest points 431 of the outside sealing portion 424 directly opposite each other across the annular base 410, and the lowest points 443 of the inside sealing portion 422 and the lowest points 433 of the outside sealing portion 424 directly opposite each other across the annular base 410. If viewed from a side of the sealing ring 400 (for example, from the perspective shown in FIG. 4B), the outside sealing portion 424 exactly blocks the inside sealing portion 422. Of course, in some other embodiments, the inside sealing portion 422 and the outside sealing portion 424 may also be configured to be inclined asynchronously with respect to the annular base 410, so that the highest point 441 of the inside sealing portion 422 and the highest point 431 of the outside sealing portion 424 are staggered with each other in the circumferential direction of the annular base 410, the lowest point 443 of the inside sealing portion 422 and the lowest point 433 of the outside sealing portion 424 are also staggered with each other in the circumferential direction of the annular base 410, and if viewed from a side of the sealing ring 400 (for example, from the perspective shown in FIG. 4B), the outside sealing portion 424 cannot completely block or does not block the inside sealing portion 422. An outer surface of the outside sealing portion 424 forms an outside sealing surface 454 (see FIGS. 4A and 4B), and an outer surface of the inside sealing portion 422 forms an inside sealing surface 452 (see FIGS. 4A, 4C and 4D). As shown in FIGS. 4C and 4D, the inside sealing surface 452 and the outside sealing surface 454 are arc-shaped on the cross section of the sealing ring 400.

Although in the embodiment of the present disclosure, the inside sealing portion 422 and the outside sealing portion 424 of the sealing ring 400 each are configured to have a contour inclined with respect to the radial direction of the annular base, in some other embodiments, it is only necessary to provide the sealing portion that is in dynamic contact with a cooperating component with a contour inclined with respect to the radial direction of the annular base 410.

The sealing ring 400 shown in FIGS. 4A through 4D, like the sealing ring 100 shown in FIGS. 1A through 1D, may also be used in the connector assembly shown in FIGS. 2A through 2D and the connector assembly shown in FIGS. 3A through 3D, and can also reduce the peak value of the insertion force applied by the operator, which is not repeated herein. It should be noted that although the embodiment of the present disclosure provides an application scenario of the sealing ring being used in the connector assembly, the sealing ring according to the present disclosure is not limited to the application in the connector assembly, but can be used between any components that need to cooperate with each other by insertion.

Although the present disclosure is described with respect to the examples of the embodiments outlined above, various alternatives, modifications, variations, improvements, and/or substantial equivalents that are known or current or to be anticipated later may be apparent to those of at least ordinary skill in the art. Furthermore, the technical effects and/or technical problems described in this description are exemplary rather than limiting; therefore, the disclosure in this description may be used to solve other technical problems and have other technical effects and/or may solve other technical problems. Accordingly, the examples of the embodiments of the present disclosure as set forth above are intended to be illustrative rather than limiting. Various changes can be made without departing from the spirit or scope of the present disclosure. Therefore, the present disclosure is intended to include all known or earlier developed alternatives, modifications, variations, improvements and/or substantial equivalents.

What is claimed is:

1. A sealing ring, comprising:
an annular base comprising an inner annular side and an outer annular side;
an inside sealing portion protruding inwardly from the inner annular side; and
an outside sealing portion protruding outwardly from the outer annular side,
wherein at least one of the inside sealing portion and the outside sealing portion has a contour undulating in an axial direction of the annular base or inclined with respect to a radial direction of the annular base.

2. The sealing ring according to claim 1, wherein:
the undulating contour forms a wavy contour.

3. The sealing ring according to claim 1, wherein:
the inclined contour comprises one highest point and one lowest point.

4. The sealing ring according to claim 2, wherein:
the undulating contour comprises at least two highest points and at least two lowest points, wherein the at least two highest points are arranged rotationally symmetrically with respect to an axis of the annular base, and the at least two lowest points are arranged rotationally symmetrically with respect to the axis of the annular base.

5. The sealing ring according to claim 1, wherein:
each of the inside sealing portion and the outside sealing portion has the contour undulating in the axial direction of the annular base or inclined with respect to the radial direction of the annular base.

6. The sealing ring according to claim 5, wherein:
the contour of the inside sealing portion and the contour of the outside sealing portion undulate or are inclined synchronously with respect to the annular base.

7. The sealing ring according to claim 5, wherein:
the contour of the inside sealing portion and the contour of the outside sealing portion undulate or are inclined asynchronously with respect to the annular base.

8. The sealing ring according to claim 5, wherein:
the inside sealing portion and the outside sealing portion each have a sealing surface with arc-shaped cross-sections.

9. The sealing ring according to claim 3, wherein:
the annular base comprises a first end and a second end in the axial direction; and
the contour comprises a first portion which is closer to the first end and a second portion which is closer to the second end, and the contour is configured such that during deformation of the contour being pressed by a component in dynamic contact therewith, the first portion of the contour is pressed and deformed by the component before the second portion, and when the first portion of the contour is pressed and deformed by the component, the second portion of the contour has not been in contact with the component or is not pressed and deformed by the component.

10. The sealing ring according to claim 1, wherein:
the annular base, the inside sealing portion and the outside sealing portion are integrally formed.

11. A connector assembly, comprising:
a female connector;
a male connector inserted into the female connector; and
a sealing ring according to claim 1, wherein the sealing ring is arranged between an outer side of the male connector and an inner side of the female connector to achieve a sealing between the outer side of the male connector and the inner side of the female connector.

12. The connector assembly according to claim 11, wherein:
the outer side of the male connector is provided with a male connector accommodation groove in which the sealing ring is at least partially retained; or
the inner side of the female connector is provided with a female connector accommodation groove in which the sealing ring is at least partially retained.
